(19) United States
(12) Patent Application Publication
(10) Pub. No.: US 2015/0027679 A1
(43) Pub. Date: Jan. 29, 2015

(54) FINNED TUBE ASSEMBLIES FOR HEAT EXCHANGERS

(71) Applicant: Holtec International, Marlton, NJ (US)

(72) Inventors: Krishna P. Singh, Hobe Sound, FL (US); Frank David Sanderlin, San Diego, CA (US); William G. Schofield, Bancroft (CA); Dmitiy Yakov Kats, San Diego, CA (US); Joseph Paul Mosher, San Diego, CA (US); Robert Charles Sloan, Boardman, OH (US); Thomas G. Haynes, III, Tampa, FL (US)

(21) Appl. No.: 14/373,122

(22) PCT Filed: Jan. 18, 2013
(86) PCT No.: PCT/US13/22269

§ 371 Date: Jul. 18, 2014

Related U.S. Application Data
(60) Provisional application No. 61/588,086, filed on Jan. 18, 2012.
(60) Provisional application No. 61/732,751, filed on Dec. 3, 2012.

(51) Int. Cl. F28B 1/06; B23K 1/00; B23K 1/20; F28F 1/30

(52) U.S. Cl. CPC F28B 1/06; F28F 1/30; B23K 1/0012; B23K 1/203
USPC 165/182; 228/223

(57) ABSTRACT

A finned tube assembly for an air cooled condenser and method for forming the same. The finned tube assembly comprises a flow conduit in the form of a bare steel tube and at least one set of fins bonded directly to the tube. In one embodiment, the tube has a non-circular cross section and the fins have a serpentine configuration. An oil based carrier and flux mixture is used in one embodiment to braze the fins onto the bare tubes, A braze filler metal may he introduced proximate to the bonding site by several different delivery mechanism. The braze filler metal may be aluminum or aluminum silicon. The finned tubes assemblies are combined in tube bundles and assembled to form an air cooled condenser which may be used in power generation, station, and other applications.

### CROSS-REFERENCE TO RELATED PATENT APPLICATIONS

The present application claims the benefit of U.S. Provisional Patent Application Ser. No. 61/588,086 filed Jan. 18, 2012 and U.S. Provisional Patent Application Ser. No. 61/732,751 filed Dec. 3, 2012 the entireties of which are hereby incorporated by reference.

### FIELD OF THE INVENTION

The present invention relates generally in thermal electric power generating plants, and more specifically to air cooled condenser finned tubes and related method for fabricating the same.

### BACKGROUND OF THE INVENTION

Rejection of waste heat in a Rankine cycle used in thermal electric power generation plants via Dry Cooling techniques instead of Wet Cooling is an inherently more environmentally friendly option. Indeed, governmental restriction on water consumption for industrial use, especially to condense waste steam in power plants, has emerged as a growing worldwide trend. Driven by the increasing scarcity of water, power plant designers have been turning to heat exchangers in the form of air cooled condensers in lieu of the conventional “water cooled” condensers. The air cooled condensers (ACCs) consist of inclined tube bundles arranged in an array of “cells” wherein the power generation plant turbine exhaust steam flows inside the tubes and is condensed by the flow of cooling air in a Cross flow arrangement delivered by axial fans located generally underneath. The steam therefore undergoes a phase change from gas to liquid between the tube inlet and outlet. To minimize the “parasitic power” (energy needed to run the fans), the dry cooling industry has steadily evolved from using multi-row finned tube bundles to a single tube row over the past 70 years.

Finned tubes have been proposed for ACCs. These finned tubes are generally comprised of aluminum cladded carbon steel tubes with brazed aluminum fins, aluminized carbon steel tubes with brazed aluminum fins, and stainless steel tubes with laser welded stainless steel fins.

The above mentioned tube configurations have several disadvantages that are limiting the widespread application of ACCs, such as: (1) carbon steel tubes are subject to flow accelerated corrosion issues that are being exacerbated by the high cycles and fast starts of the latest generation of power plants; (2) contamination of condensate (deleterious iron carry over) by corrosion of the carbon steel tubing and associated additional water treatment required to address the inure stringent water chemistry requirements of modern power plants; and (3) the high capital cost associated with stainless steel tubes with laser welded stainless steel fins.

An improved tube construction and fabrication process is desired.

### SUMMARY OF THE INVENTION

The present disclosure provides an improved finned tube assembly and a method for bonding an aluminum fin to an uncoated bare steel tube. In one embodiment, the method employs a flux mixture comprising powdered flux and an oil based carrier. In a preferred. embodiment, water is not used in the flux mixture. Advantageously, the method advantageously eliminates the need to first provide an aluminum clad layer (or otherwise aluminized surface) on the outer surface of the tube for bonding the tube to the fin before beginning the brazing process, eliminates drying of fluxed tubes, and reduces the deleterious intermetallic layer (e.g. FeAl3) between the dissimilar metals which is formed during brazing. The latter is beneficial because FeAl3 is relatively brittle so that it is desirable to minimize the thickness of this layer to avoid joint fracture. The method according to the present disclosure provides long term corrosion protection of the external tube surface after brazing. The method is applicable to tubes constructed from carbon steels, ferritic stainless steels, austenitic stainless steels, and other steel alloys.

In one preferred embodiment, the steel core tube is stainless steel. The stainless steel core tube provides a unique solution to the flow accelerated corrosion and iron transport issues that currently plague the power plant air cooled condenser industry. This invention particularly addresses the more stringent water chemistry requirements and cyclic power plant loading scenarios that exist today.

The present disclosure further provides a heat exchanger of the air cooled condenser (ACC) type having high efficiency, lower manufacturing costs, and longer life than heretofore known air cooled condensers. Both the method and heat exchanger according to the present disclosure allow for maintaining cost effective manufacturing.

According to one embodiment of the present invention, a tube assembly for a heat exchanger includes a bare steel tube and at least one set of aluminum fins bonded directly to an exposed outer surface of the bare steel tube by as brazing filler metal comprised of aluminum. In one embodiment, the steel tube is made of stainless steel. In another embodiment, the steel tube is made of low carbon steel. The set of aluminum fins has a serpentine configuration comprising peaks and valleys. In a certain embodiment, the steel tube has an oblong cross-sectional shape.

According to another embodiment of the present invention, a finned tube brazing preassembly for heat processing in a brazing furnace is provided. The preassembly includes a bare steel tube having an exposed outer surface, a set of aluminum fins, a fluoride based flux and oil. based carrier mixture disposed between the bare steel tube and the set of aluminum fins, and a brazing filler metal comprising aluminum. The brazing filler is disposed proximate to the set of aluminum fins and the flux and oil based carrier mixture for bonding the fins to the tube. The brazing filler metal forms a brazed bond between the bare steel tube and set of aluminum fins when heat processed in the brazing furnace. In one embodiment, the oil based carrier is vanishing oil. In one embodiment, the flux and oil based carrier mixture is applied to the exposed outer surface 124 of tube 102 at a rate of about 25 g/m2 flux and about 35 g/m2 oil based carrier which may be vanishing oil. In various embodiments, the bare steel tube is preferably stainless steel or low carbon steel.

According to another embodiment of the present invention, an air cooled condenser sized for industrial and commercial application is provided. The air cooled condenser includes an inlet steam distribution header for conveying steam, a condensate outlet header for conveying condensate, and an array of tube bundles. The tube bundles each comprise a plurality of finned tube assemblies having a bare steel tube with an exposed outer surface and a set of aluminum fins brazed directly onto the tube by a brazing filler metal. The steel tubes are spaced apart by the aluminum fins. The steel tubes further have an inlet end fluidly coupled to the inlet steam distribution header and an outlet end fluidly coupled to the outlet header. A forced draft fan is provided and arranged to blow air through the tube bundles. In various embodiments, the bare steel tube is preferably stainless steel or low carbon steel.

A method for forming a tube assembly for an air cooled condenser is provided. The method includes the steps of providing a bare steel tube having an exposed exterior surface of steel; providing an aluminum tin; applying a flux and oil based carrier mixture onto the exposed exterior surface of the steel tube; providing, a brazing filler metal; bringing into mutual contact the bare steel tube, aluminum fin, flux and oil based carrier mixture, and brazing filler metal, wherein the bare steel tube, aluminum fin, flux and oil based carrier mixture, and brazing filler metal collectively define a finned tube brazing preassembly; loading the finned tube brazing preassembly into a brazing furnace; and heating the filmed tube brazing preassembly to a temperature sufficient to melt the brazing filler metal and bond the aluminum fin directly onto the bate steel tube. In various embodiments, the bare steel tube is preferably stainless steel or low carbon steel.

A method for condensing steam using, an air cooled condenser according to the present disclosure is also provided. The method includes: providing an air cooled condenser comprising an array of tube bundles, an inlet steam distribution header conveying steam, a condensate outlet header conveying condensate, and a forced draft fall blowing air through the tube bundles; the tube bundles each comprising a plurality of finned tube assemblies having a bare steel tube with an exposed outer surface and a set of aluminum fins brazed directly onto the tube with a brazing filler metal, the tubes having an inlet end fluidly coupled to the inlet steam distribution header and an outlet end fluidly coupled to the outlet header; flowing steam through the inlet steam distribution header; receiving steam through the inlet end of each tube; condensing the steam in each tube between the inlet and outlet ends; passing liquefied water condensate through the outlet end of each tube; and collecting the condensate in the condensate outlet header. In various embodiments, the bare steel tube is preferably stainless steel or low carbon steel.

A flux mixture suitable for brazing aluminum fins onto a bare steel tube is provided. In one embodiment, the flux mixture includes a flux powder and an oil based carrier. In one embodiment, the oil based carrier is preferably an aliphatic hydrocarbon, and more preferably a vanishing oil, The flux powder and oil based carrier form a flux gel or paste suitable for application to an air cooled condenser tube or other structure.

### BRIEF DESCRIPTION OF THE DRAWINGS

FIG. 1A is a perspective view of an air cooled condenser system according to one embodiment of the present disclosure.

FIG. 1B is a schematic flow diagram of a Rankine cycle and components for a thermal power generating plant.

FIG. 2A is a perspective view of a finned tube assembly used in the air cooled, condenser of FIG. 1.

FIG. 2B is a transverse cross-sectional view of the tube assembly of FIG. 2B;

FIG. 2C is a transverse cross-sectional view of an alternative embodiment of a tube assembly usable in the air cooled condenser of FIG. 1.

FIG. 2D is a transverse cross-sectional view of another alternative embodiment of a tube assembly usable in the air cooled condenser of FIG. 1.

FIG. 2E is a transverse cross-sectional view of another alternative embodiment of a tube assembly usable in the air cooled condenser of FIG. 1.

FIG. 2F is a transverse cross-sectional view of another alternative embodiment of a tube assembly usable in the air cooled condenser of FIG. 1.

FIG. 3 is an exploded perspective view of the tinned tube assembly of FIG. 2A.

FIG. 4 is an exploded perspective view of a first embodiment of a finned tube preassembly for forming a tube assembly usable in the air cooled condenser of FIG. 1.

FIG. 5 is an exploded perspective view of a second embodiment of a finned tube preassembly for forming, a tube assembly usable in the air cooled condenser of FIG. 1.

FIG. 6 is an exploded perspective view of a third embodiment of a finned tube preassembly for forming, a tube assembly usable in the air cooled condenser of FIG. 1.

FIG. 7 is a perspective view of a several tube assembly of FIG. 2 brazed together to form a portion of a tube bundle usable in the air cooled condenser of FIG. 1.

All drawings are schematic and not necessarily to scale.

### DETAILED DESCRIPTION OF THE DRAWINGS

The features and benefits of the invention are illustrated and described herein by reference to exemplary embodiments. This description of exemplary embodiments is intended to be read in connection with the accompanying drawings, which are to be considered part of the entire written description. In the description of embodiments disclosed herein, any reference to direction or orientation is merely intended for convenience of description and is not intended in any way to limit the save of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing, under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Accordingly, the disclosure expressly should not be limited to such exemplary embodiments illustrating some possible non-limiting combination of features that may exist alone or in other combinations of features.

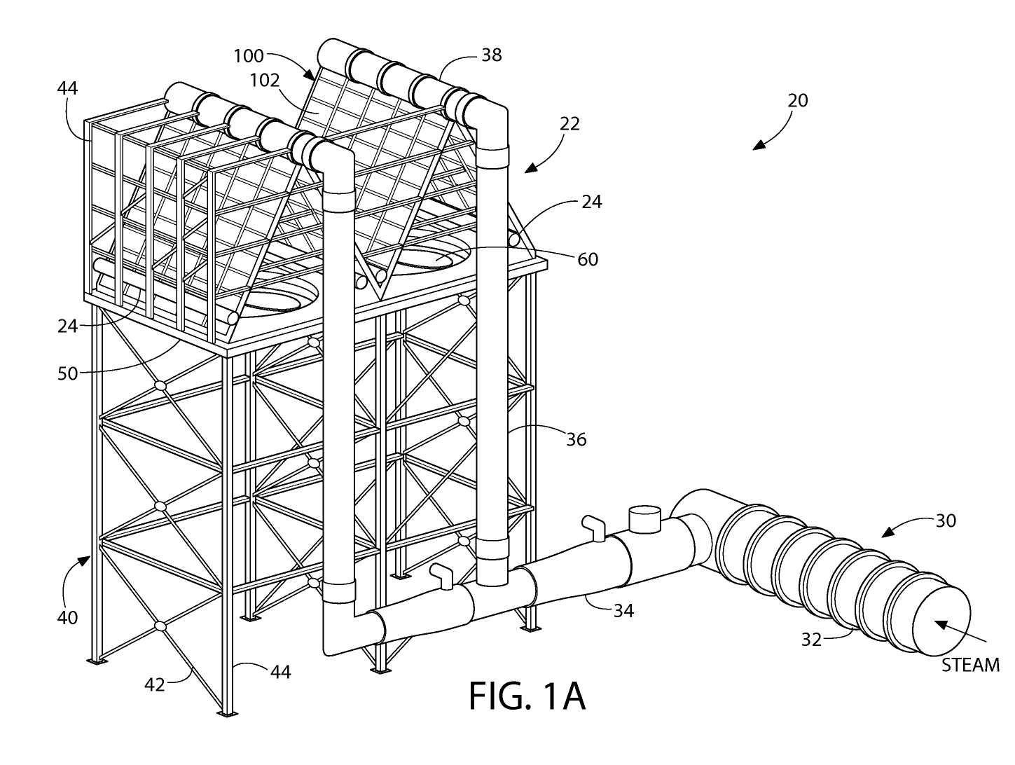

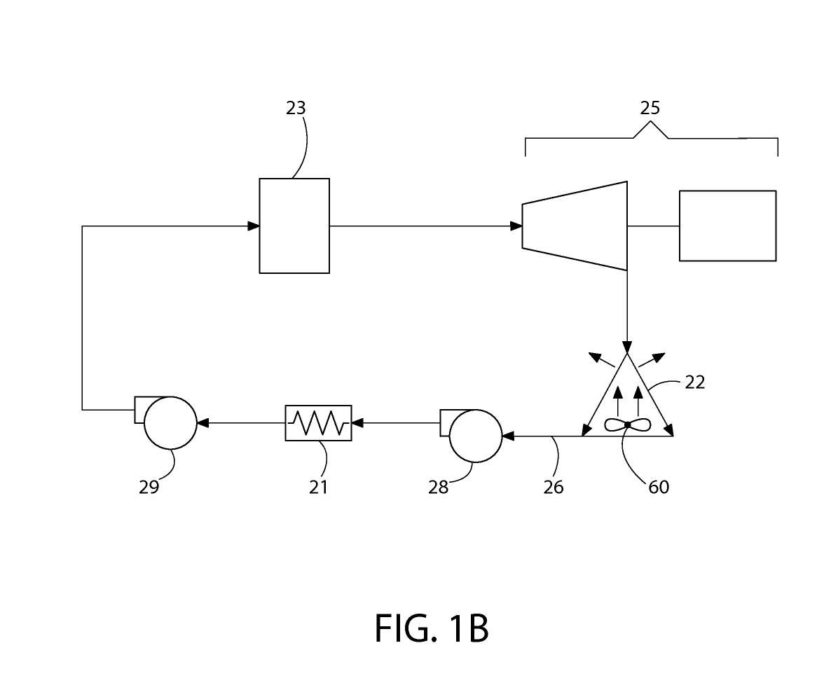

FIG. 1A depicts a heat exchanger in the form of an air cooled condenser (ACC) system 20 as used in a thermal electric power generation plant for converting low pressure steam into liquid (“condensate”). Air cooled condenser system 20 includes an air cooled condenser 22 and exhaust steam supply 30 which in one embodiment is fluidly connected to the steam exhaust from the turbine of a turbine-generator set 25 (see FIG. 1B) as will be known to those skilled in the art. In the present embodiment being described, the fluid is initially low pressure turbine exhaust steam (vapor phase of water) upstream oldie air cooled condenser and liquid condensate (condensed water) downstream of the air cooled condenser.

In one embodiment, the steam supply 30 includes a main steam duct 32 which is fluidly coupled to a piping distribution manifold 34 that branches into a plurality of risers 36 and distribution headers 38 for conveying inlet steam into the air cooled condenser 22, as shown. Risers 36 may be generally vertically oriented and distribution headers 38 may be generally horizontally oriented. Each set of risers 36 and distribution headers 38 supply steam to an array of condenser tube bundles 100 comprised of a plurality of individual finned tubes 102. Tubes 102 each have inlet ends 126a fluidly coupled to one of the distribution headers 38 to receive water in the steam phase and outlet ends 126b fluidly coupled to a condensate outlet header 24 which collects the condensed steam or condensate (liquid phase water) from the tubes.

With additional reference to FIG. 1B showing a schematic diagram of a conventional Rankine cycle of a thermal electric power generation plant, the outlet headers 24 are fluidly connected to condensate return piping 26 to route the liquid condensate back to a condensate return pump 28 which pumps the condensate to the steam generator (“boiler”) feed system. The condensate (“feedwater” at this stage in cycle) is generally pumped through one or more feedwater heaters 2.1 to pre-heat the feedwater. Feedwater pumps 29 pump the feedwater to a steam generator 23 (e.g. nuclear or fossil fuel fired) where the liquid feedwater is evaporated and converted back to steam. The steam flows through a turbine-generator set 25 which produces electricity in a known manner. The pressure of the steam drops as it flows through the turbine converting thermal and kinetic energy into electric energy. The low pressure steam at the outlet of the turbine is collected and returned to the main steam duct 32 to complete the now path back to the air cooled condenser system 20.

Referring back to FIG. 1A, the air cooled condenser 22 further includes a support structure 40 to elevate the tube bundles 100 above the ground so that air may be blown vertically up through the tube bundles from below in one possible embodiment by an air moving system comprised of a plurality of forced draft fans 60 (fan blade shown in FIG. 1A). The fans 60 are each mounted on a fan deck platform 50 supported by support structure 40. In one preferred embodiment, the fan deck platform 50 and tube bundles 100 are elevated vertically above the ground by a distance that is at least as great as the height of the tube bundles (defined as being measured from the distribution header vertically to the outlet header 24. The support structure 40 may include columns 44 and cross-bracing as required to support the weight of the tube bundles 100, fans 102, risers 36, distribution headers 38, and outlet headers 24, as well as to laterally stiffen the structure to compensate for wind loads. In some embodiments, windwalls 44 may be provided around the tube bundles 102 to counter the effects of prevailing winds which may adversely affect normal upwards and outwards airflow through the tube bundles 100 from the forced draft fan 60.

The air cooled condenser 22 may be configured such that a single steam distribution header 38 feeds a pair of spaced apart tube bundles 102. In one embodiment, the tube bundles 100 in each pair may be arranged at an angle to each other as shown forming a generally tent-like triangular configuration with a fan 60 disposed between and at the bottom or below the tube bundles. Each tube bundle 100 has a separate outlet. header 24 disposed near and supported by the fan deck platform 50. The outlet headers 24 may be spaced apart on opposing sides of the fan 60 in one non-limiting arrangement. The tube bundles 100 may be disposed at any suitable angle to each other.

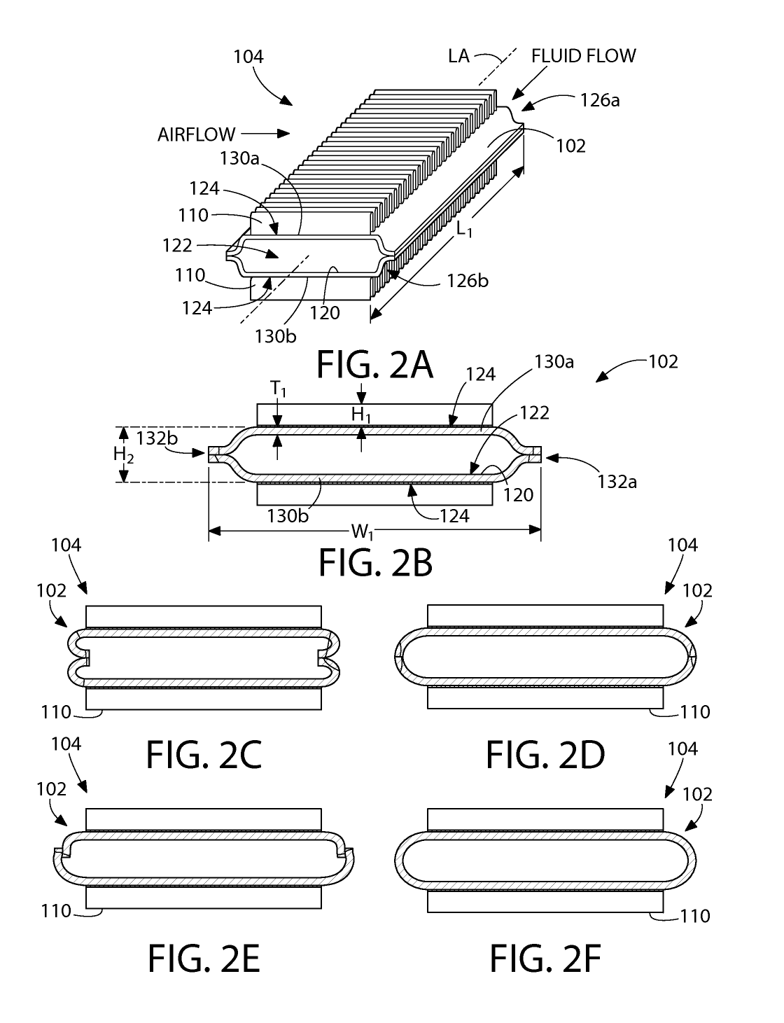

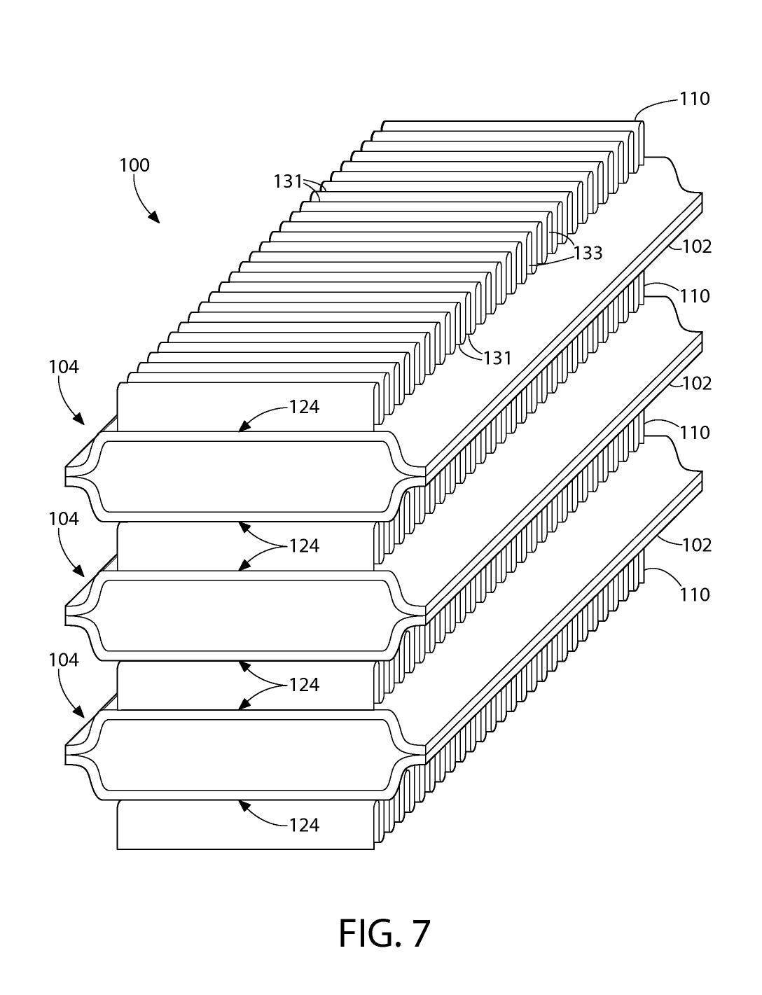

FIG. 2A depicts an exemplary finned tube assembly 104 of tube bundle 100 which includes a longitudinally-extending elongated tube 102 and two sets of cooling fins 110 bonded to the tube by a unique brazing method according to the present disclosure, as further described herein. A plurality of these tube assemblies 104 are essentially stacked and arranged together in adjacent parallel relationship forming the tube bundles 100(see, e.g. FIG. 7), in one embodiment, tube bundle 100 is comprised of a single row of adjacent tube assemblies 104 each fluidly connected between a distribution header 38 and an outlet. header 24 (see, e.g. FIG. 1A). In a preferred embodiment, as best shown in FIG. 7, a single set of fins 110 is disposed between each tube 102 which are laterally spaced apart by the fins.

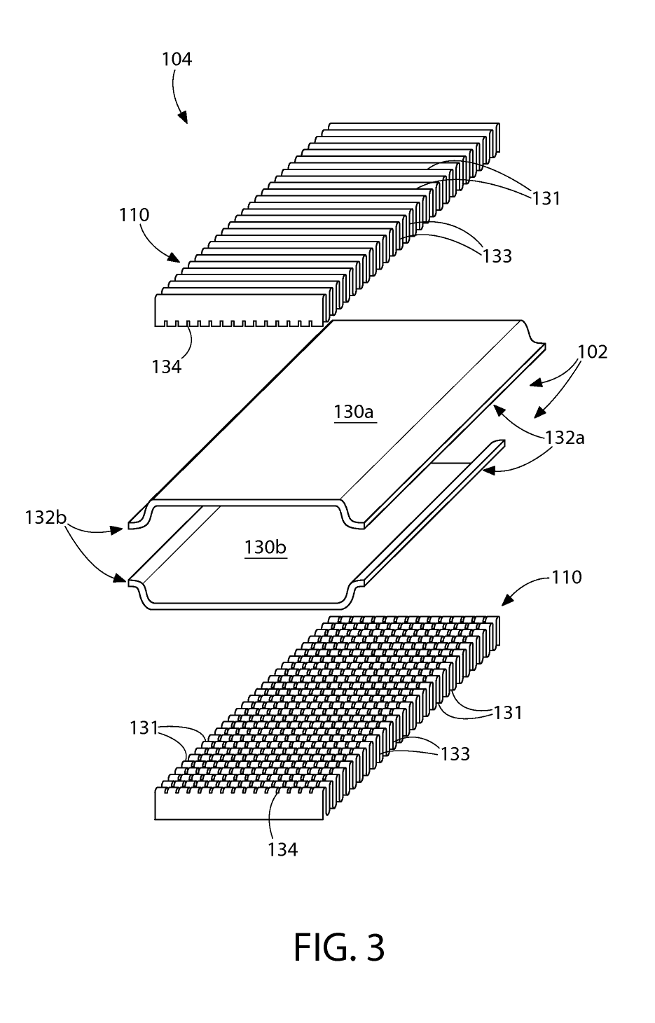

FIG. 3 depicts an exploded view of as finned tube assembly 104 prior to brazing, which may be defined as a finned tube preassembly.

Referring to FIGS. 2, 3 and 7, tube 102 has an inner surface 122 that forms a longitudinal internal flow conduit or passageway 120 and an exposed outer surface 124 on which the two sets of fins 110 are bonded, as limber described herein. Internal passageway 120 extends from an inlet end 126a which is fluidly connected to distribution header 38 to an opposing outlet end 126b which is fluidly connected to outlet header 24. The internal passageway 120 is in fluid communication with both the distribution header 38 and outlet header 23. Passageway 120 is configured and dimensioned for transporting a steam-liquid water phase mixture through the tubes 102 of the air cooled condenser 22. Internal passageway 120 is a sealed flow conduit which in operation with fins 110 performs the function of removing heat tom the turbine exhaust fluid which enters inlet end 126a of tube 102 in a steam phase from distribution header 38, condenses in flowing through the tube via heat transfer, and leaves the outlet end 126b in the liquid phase (“condensate”) which is collected in the outlet header 24.

Tube 102 (and the resulting internal passageway 120) preferably may have a transverse cross-section that is non-circular and may he generally described as oblong, elliptical, or ovoid in shape. In the illustrated preferred embodiment, tube 102 generally comprises opposing top and bottom substantially flat walls 130a, 130b that are connected by lateral walls 132a, 132b. In one embodiment, flat walls 130a and 130b are oriented parallel to each other. Flat walls 130a-b each have a width W1 that is larger than height H2 of lateral sections 132a-b as further shown, for example, in FIG. 2B. Flat walls 130a, 130b correspondingly define respective flat exposed outer surfaces 124 on which fins 110 are bonded as further described herein.

FIGS. 2B-F show several examples of possible embodiments of tubes 102 having a non-circular transverse cross-sections and flat walls 130a, 130b in accordance with the present disclosure, which are suitable for employing the fin-to-tube bonding process described herein The tubes 102 may each be formed as a single unitary monolithic structure (e.g, by extruding) in cross-section as shown in FIGS. 2F and 4-6, or be comprised of two or more configured tube wall segments that are joined together at joints by a suitable fabrication means used in the art to form a sealed flow conduit such as seam welding, brazing, crimping, or other techniques suitable to provide a leak-proof tube construction.

It will be appreciated that embodiments of the invention are not limited to any particular type of tube construction and the tube 102 can take on as wide variety of non-circular transverse cross-sectional shapes. For example, the top and bottom flat walls 130a, 130b may have an outwardly convex transverse cross-section being arcuately curved away from the longitudinal axis LA of the tube to resist deformation in partial or full vacuum conditions inside the tube.

Referring to FIG, 2A, tubes 102 may be configured and dimensioned for industrial or commercial application in an air cooled condenser system used in a thermal power generation plant to cool and condense exhaust steam from the turbine. In such applications, tubes 102 extend a longitudinal length L1 which in some embodiments may be between about 10 to 60 feet. The width W1 the tube 102 may be in a range between about 4 to 18 inches. The thickness of the tube wall is preferably sufficient to promote good heat transfer and support the weight of the tube and fins 110. In one embodiment, for example, the tube wall thickness T1 (e.g. walls 130a, 13b and 132a, 132b measured in transverse cross-section as shown in FIG. 2A) may be about 0.035 to 0.12 inches. In one embodiment, the wall thickness T1 is about 0.050 inches. Of course, the invention is not so limited and the longitudinal length L1, width W1, and wall thickness can be any desired measurement. Moreover, while the tube. 102 is exemplified as extending along a linear longitudinal axis, the tube 102, in other embodiments, can include curves, bends and/or angles in one or more orthogonal directions.

The tube 102 dimensions can be optimized for varying market conditions based on materials used. For example, a tube width W1 of 9.25 inches (235 nm) by a height H2 of 0.79 inches (20 mm) with a 0.039 inch (1 mm) wall thickness T1 have been determined. feasible with SS409 material. The accompanying AL3003 fin is 8.5 inches (215 mm) long (measured longitudinally along the longitudinal axis LA), 0.83 inches (21 mm) high H1, and 0.01 inches (0.25 mm) thick (sheet thickness) placed at a fin pitch of 0.09 inches (2.31 mm).

For application in an air cooled condenser suitable for an industrial use such as in a power generation plant, tube 102 is preferably constructed of steel. Any suitable steel having appropriate heat transfer properties for a given application may be used. In one preferred embodiment, the steel may be stainless steel for corrosion resistance. Non-limiting examples of suitable stainless steels are Grade 409SS or Grade 3Cr12 stainless. Other suitable ferritic or austenitic stainless steels may be used.

In a preferred embodiment, tubes 102 are constructed of bare steel having an exposed outer surface 124 on which fins 110 are directly bonded has a metallurgical composition of steel composition. In one embodiment, tube 102 therefore has a homogeneous metallurgical composition comprised uniformly of steel from end to end and in transverse cross-section. between the inner surface 122 and exposed outer surface 124.

Tubes 102, and in particular exposed outer surface 124 on top and bottom flat walls 130a, 130b to which the fins 110 are bonded, are preferably free of any coating, cladding, surface chemistry modification, impregnation, or other application which incorporate another material other than steel such as particularly metals, alloys, or compositions containing aluminum. As further described herein, the fin-to-tube bond is advantageously formed on bare steel without the aid and expense of first applying an aluminum coating on or aluminizing the exposed outer surface 124.

Referring to 2A-F and 3, fins 110 will be described in greater detail. Each set of fins 110 is preferably formed of a corrugated sheet of material having a high coefficient of thermal conductivity, such as aluminum in a preferred embodiment. The metal sheet is originally flat and then shaped by a suitable fabrication technique to form the corrugations. The corrugated sheets 20A, 20B can be of any length. Either a single or a plurality of the corrugated sheets can be used to cover substantially the entire longitudinal length L1 of a flat wall 130a or 130b of the finned tube assembly 104. In other embodiments, corrugated sheets of material may cover less than the entire length L1 or only intermittent portions of the flat walls 130a, 130b.

An aluminum sheet usable for forming fins 110 according to the present disclosure is a flat element which may be made from aluminum alloy in the 1xxx, 3xxx, 5xxx or 6xxx families as designated by the Aluminum Association, which is adapted and suitable for heat absorption and discharge to a cooling medium flowing past the sheet. In one embodiment, without limitation, exemplary corrugated fins 110 may be formed from of sheets of Al 3003 material having a thickness of about 0.010 inches.

Each of the sets of fins 110 has a generally serpentine configuration as shown in FIGS. 2-7 (inclusive of FIGS. 2A-F) comprising a plurality of undulating and alternating peaks 131 and valleys 133. Lateral airflow passages are formed in the gaps between the peaks and valleys for airflow generally perpendicular to the length LI of the tube and longitudinal axis LA (see FIG. 2A). The peaks 131 define mounting base areas on opposing top and bottom sides of fins 110 for bonding to tubes 102. The tips of the peaks 131 form laterally extending ridges disposed perpendicular to the longitudinal length L1 and longitudinal axis LA of tubes 102 which are bonded to the tube 102 during, the brazing, process. Except for the two outermost tubes 102 in a tube bundle 100, the ridges are configured to abuttingly contact the exposed outer surfaces 124 on top and bottom flat walls 130a, 130b of adjacent tubes for bonding to the walls in the manner described herein.

In one embodiment as shown in FIG. 3, the fin 110 to tube 102 joint may be made by an interrupted fin edge having a square saw tooth configuration. The contact surfaces between the fin and the bare exposed outer tube surface 124 on top and bottom flat walls 130a, 130b is made of narrow metal strips of fin punctuated by narrow vertically extending slits 134 formed in the fin. Slits 134 extend perpendicular to outer surface 124 and flat walls 130a, 130b in the embodiment shown. Slits 134 preferably may be evenly spaced apart as shown, or alternatively have unequal spacing. Slits 134 are formed in the peaks 131 of the fin 110 and extend partially down/up along the height H1 of the fin (see FIG. 28 defining height dimension). Using this saw tooth configuration, heat produced during the brazing process advantageously does not cause excessive surface deformation in the tube. This unique fin base design creates a controlled yield zone in the base of the fin (i.e. where peaks 131 abut flat walls 130a, 130b) to accommodate the differential thermal expansion rates of the aluminum fin and steel tube. This feature significantly mitigates deformation of the tube during the post braze cool down by allowing the fin to contract more than the parent tube.

In other embodiments, the edges of the fins 110 at the peaks 131 may be laterally continuous without interruption, as shown for example in FIG. 2A.

According to an aspect of the present invention, a process or method for bonding an aluminum fin to an uncoated bare steel tube is provided. In a preferred embodiment, the bonding method is brazing. An overview of components, materials, pre-brazing assembly steps, and furnace brazing process will first be described.

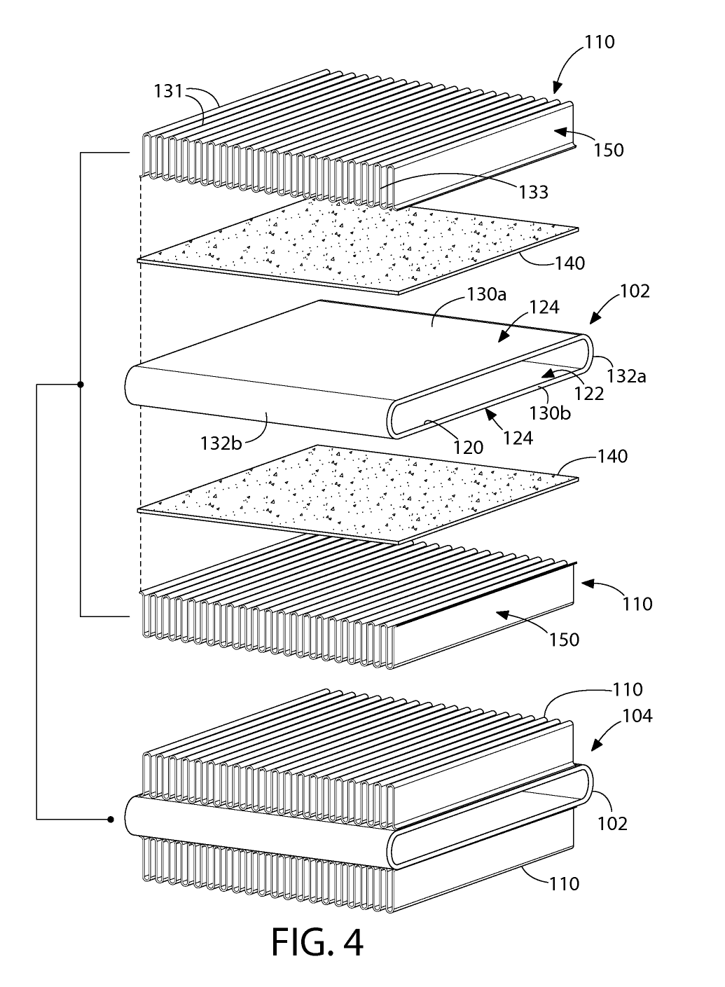

Referring to FIG. 3 for general reference, the method for bonding aluminum fins 110 to bare steel tubes 102 comprises essentially at least the following general steps (to be further explained herein): (1) providing at least one first structural component in the form of a bare steel. tube 102 which in this embodiment is stainless steel, oil based carrier brazing flux 140 gel or paste which preferably contains a vanishing oil, brazing filler metal 150 in one of three physical delivery formats as shown in FIGS. 4-6 and further described herein, and at least one other second structural component in the form of an aluminum fin 110; (2) bringing these components into physical contact; (3) heating these components in a brazing furnace to a temperature between about 577 C and 610 C, preferably between the temperatures of about 585 C and 600 C; and (4) subsequently holding this temperature range for about two to six minutes, preferably about three to five minutes, wherein a brazed bond. occurs on at least one point of contact between the tubes and fins in which the braze filler metal is used as a bonding agent.

The method according to the invention is based on the finding that the overall time the braze filler metal is at brazing temperature may be significantly reduced, i.e., by at least 10%, if the flat outer surface 124 of the tube 102 is not coated or clad with aluminum or another material from a previous operation prior to brazing. This reduction of total time at or above the brazing temperature reduces the formation of intermetallics (FeAl3) formed between the dissimilar materials. The method is also less costly because the tinned tube assembly 104 does not have to be dried (eliminate water) before brazing.

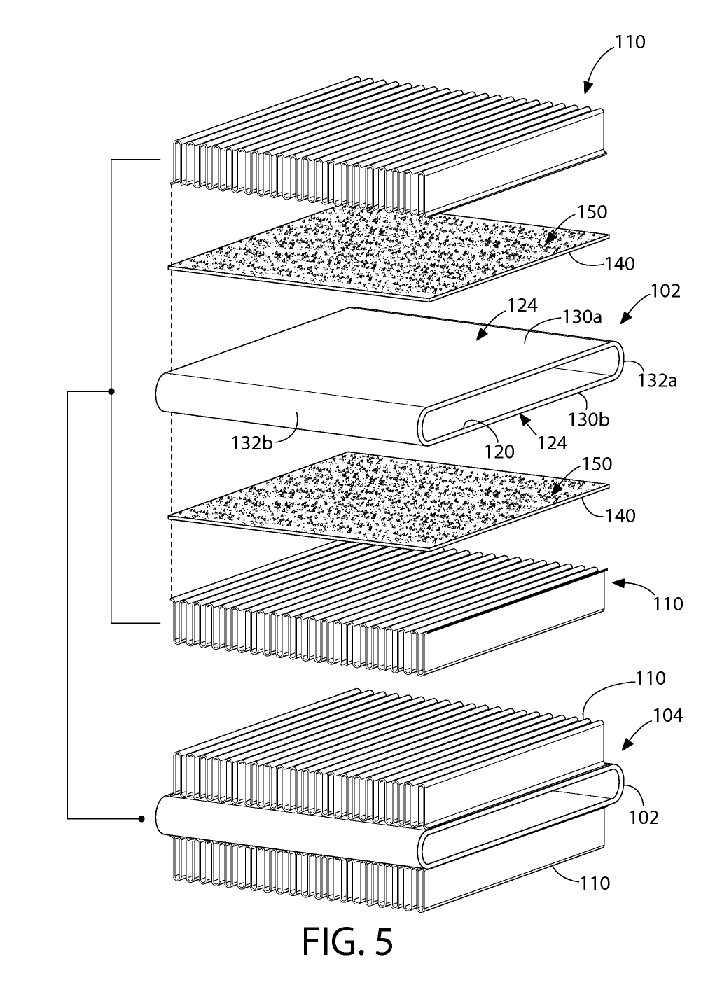

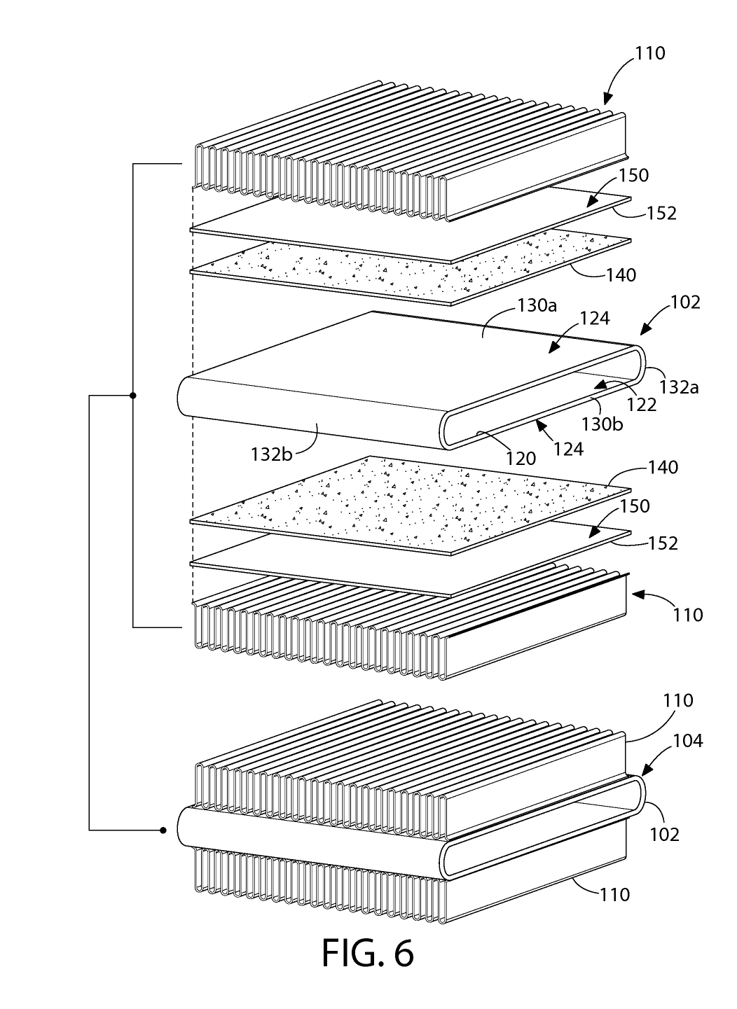

Upon heating of the fins 110 and tube 102 brought into abutting contact with each other, the braze filler metal and brazing substrates melt together in a single step, it being provided according to the invention that the oil based carrier braze flux 140 gel and brazing filler metal 150 delivered as an addition to the flux brazing gel (FIG. 5) or as a foil sheet (FIG. 6) or as a clad layer rolled onto the aluminum fin (FIG. 4) is then used as a brazing material. This offers the advantage that an aluminum clad material has not been placed through a previous heating cycle before brazing. This reduces cost of manufacture and reduces the negative impact of intermetallic formation because the cladding and brazing process is the same step. There is also power consumption savings on the whole which is accompanied by lower costs.

In the method according to the invention, when the brazing filler metal 150 is supplied in the form of a foil sheet 152, as further described herein, the foil sheet is in abutting contact with outer surface 124 of the tube 102, thereby when the foil sheet melts during the brazing process, the external surface of the tube is imparted with enhanced corrosion protection from the aluminum-silicon layer. In one representative example, without limitation, an aluminum silicon coating having a thickness of about 25 microns may be deposited. on the steel tube 102 by the brazing process.

In one preferred and present embodiment being discussed, tube 102 is stainless steel. The brazing method according to the present invention can be applied to both ferritic and austenitic stainless steel tubes.

As noted above. FIGS. 4-6 show three possible approaches for introducing the brazing filler metal 150 into the brazing process. These three figures each depict an exploded view of a finned tube assembly 104 prior to brazing with components and products used during the brazing process to bond the fins 110 to the steel tube 102. Accordingly, FIGS. 4-6 depict the un-fused components used to braze and form a permanently bonded finned tube assembly, which may be defined herein as a finned tube brazing preassembly. In all three filler metal 150 delivery mechanisms described herein, the aluminum or aluminum silicon tiller metal is provided proximate to the bonding site between the aluminum fins 110 and the exposed outer surface 124 of the steel tube 102 for brazing the fins to the tube.

The brazing tiller metal 150 preferably has a preponderance of aluminum, as much as 85 weight % or more, where the remaining proportion is predominantly silicon. Accordingly, a preferred brazing filler metal is aluminum silicon (AlSi). In some embodiments, the brazing filler metal ma contain about 6-12% silicon. Zinc may be added to the brazing filler metal alloy to lower the melting temperature, thereby allowing the brazing to take place at a lower temperature range (540 C to 590 C).

Referring to FIG. 4, the brazing filler metal 150 may be provided as clad layers hot rolled or otherwise bonded onto an aluminum sheet which forms a cladded fin 110. The aluminum fin 110 typically aa3003, is cladded with an AlSi brazing alloy consisting of about 6 to 12% silicon. The addition of silicon promotes brazing by reducing the melting temperature of the alloy, decreasing the surface tension and thereby increasing the wettability of the alloy in addition to minimizing the intermetallic alloy (e.g. FeAl3) layer thickness. The thickness of the AlSi clad layer on the fin sheet metal is between about 10% and 20% of the total thickness of the fin 110, and preferably about 15%.

In one possible embodiment, tin 110 may therefore be constructed as a three-layer composite having an aa3003 aluminum core with brazing filler metal 140 cladded on each side. In one exemplary embodiment, a suitable cladded fin composite construction is aa4343/aa3003/aa4343. The aa4343 cladding is an AlSi composition having a silicon content of about 6.8-8.20%. A representative non-limiting thickness for fin 110 constructed in this manner is about 0.012 inches. Other suitable thicknesses of the fin and cladding may be provided.

The foregoing resulting tube assembly 104 prior to brazing and bonding of the fins 110 onto tube 102 is shown in FIG. 4. Tube 102 is bare steel (i.e. uncoated and not aluminized in any manner), and preferably stainless steel in this embodiment. Flux 140 is applied between the cladded fins 110 and flat outer surfaces 124 on top and bottom flat walls 130a, 130b. The assembly is clamped together and ready for heating in the brazing furnace to bond the fins to the tube.

Referring to FIG. 5, the brazing filler metal 150 may alternatively be provided as an additive mixed with the flux 140. A powder based filler metal such as aluminum powder may be used. In one embodiment, a powdered AlSi brazing alloy is used, such as without limitation as 4343 (6.8-8.2% Si), an 4045 (9-11% Si), or an 4047 (11-13% Si) which are suitable, is added to the flux 140 and beneficially increases the exterior corrosion protection of the stainless steel. Preferably, the brazing, alloy used for the filler metal 150 is as 4045 or 4047, and more preferably 4045 in some embodiments dependent upon the brazing oven temperature profile used. This is particularly advantageous for heat exchange's that are located in aggressive environments such as those in salt air or in the vicinity of chemical plants whose emissions attack most corrosion-prone metals. Specimens subjected to a prolonged ASTM b-117 salt spray test (750 hours) are used to confirm corrosion resistance in marine air environment.

The foregoing resulting tube assembly 104 prior to brazing and bonding of the fins 110 onto tube 102 is shown in FIG. 5, Tube 102 is bare steel (i.e. uncoated and not aluminized in any manner), and preferably stainless steel in this embodiment. Fins 110 are uncladded and formed as a single layer sheet of aluminum (e.g. as 3003) as described herein. Flux 140 is applied between the uncladded fins 110 and flat outer surfaces 124 on top and bottom flat walls 130a, 130b. The assembly is clamped together and ready for heating in the brazing furnace to bond the fins to the tube.

Referring to FIG. 6, the brazing filler metal 150 may alternatively be provided in the form of a sheet of brazing foil 152. In one embodiment, the foil may be an AlSi material such as without limitation as an example an 4045. Foils 152 having a representative sheet thickness of about 0.010 to 0.15 inches may be used. In one embodiment, the sheet thickness of foil 152 used may be about 0.015 inches.

The foregoing resulting tube assembly 104 prior to brazing and bonding of the fins 110 onto tube 102 is shown in FIG. 6. Tube 102 is bare steel (i.e. uncoated and not aluminized in any manner), and preferably stainless steel in this embodiment. Brazing foil 152 is placed against the peaks 131 of the fins 110. Flux 140 is applied between the foil 512 and flat outer surfaces 124 on top and bottom flat walls 130a, 130b. The assembly is clamped together and ready for heating in the brazing, furnace to bond the fins to the tube.

The fin and the tube assembly 104 according to FIGS. 4-6 described above are brazed together within a controlled atmosphere brazing furnace at a temperature suitable to form a bond between the fin and tube. Any suitable commercially available brazing, furnace may be used to braze the finned tube assemblies 104 formed according to the present disclosure.

A suitable brazing flux such as a fluoride based flux with a cesium or lithium additive, is preferably utilized to sequester the negative effects of the chromium and nickel compounds within the stainless steel parent material. Cesium and or lithium additives to fluoride based fluxes bind and retard the negative effects of chromium and nickel at brazing temperatures. This practice requires a very specific time vs. temperature brazing cycle that is both shorter in duration and lower in temperature. This approach further enhances the braze joint strength and toughness by reducing the intermetallic layer (e.g. FeAl3) thickness within the braze joint

Suitable cesium and lithium fluxes are commercially available under the brand name NOCOLOK® from Solvay Fluor GmbH of Hannover, Germany. Advantageously, this eliminates the current general industrial practice of requiring either a roller clad or aluminized layer on the parent tube 102 material to enable using aluminum-to-aluminum braze processes. This will reduce labor and material costs while improving the heat transfer rate.

The inventors have discovered that mixing an oil-based additive to the flux admixture instead of water for a carrier as conventionally used in the art to prepare a spreadable flux paste or gel from a powdered flux product produces improved brazing performance and adhesion between aluminum fins and bare steel tubes in the brazing furnace. In one preferred embodiment, a suitable oil-based Carrier is an aliphatic hydrocarbon such as without limitation vanishing oil or lubricant. This oil-based carrier advantageously evaporates during processing and therefore does not interfere with the brazing.

A suitable non-aqueous oil based carrier is Evaplube brand vanishing oil which is commercially available from General Chemical Corporation of Brighton, Mich. In one embodiment, Evap-Lube 2200 has been used. This product is in a liquid oil form and has a specific gravity of 0.751-0.768 (water 1.0), boiling, point of 340-376 degrees F. vapor pressure at 68 degrees F. of 0.5 mmHg, evaporation rate of 0.16, and is 100% volatile by volume.

To prepare suitable spreadable flux mixtures comprised of flux powder (e.g. NOCOLOK® flux) and an oil based carrier (e.g. Evap-Lube 2200), the relative amounts of each used preferably may be in the ranges of about 40-65% by weight vanishing oil to about 60-35% by weight flux, and more preferably about 48-58% by weight vanishing oil to about 52-42% by weight flux. In one representative embodiment, without limitation, about 53% by weight vanishing oil may be used with the remaining weight percentage (47%) of product in the mixture being flux or flux with additional additives.

The foregoing oil based carrier and powdered flux mixtures produce a very viscous flux mixture (similar to a gel or well paper paste in consistency and viscosity) that is readily spreadable on the tubes 102 in preparation for brazing. Advantageously, for the present brazing application, the Evap-Lube 2200 vanishing oil evaporates readily leaving little or no residual oils, and therefore does not interfere with the formation of a brazed bond between the fins 110 and bare steel tube 102. The oil based carrier and fluoride based flux brazing gel or paste is an admixture of halides including, but not limited to, potassium aluminum fluoride, cesium aluminum fluoride, and lithium aluminum fluoride.

A suitable representative application rate of the flux and oil based carrier mixture may be about 25 g/m² flux to 35 g/m² of vanishing oil.

In alternative embodiments a long chain alcohol may be added to farther extend and improve the spreadability of the flux-oil based carrier mixture which may be used for longer lengths of bare steel tubes 102 to be prepared for brazing. In certain embodiments, the long chain alcohol may be glycol including hexylene glycol and propylene glycol. Glycol or another long chain alcohol may be added to the flux and oil based carrier mixture in amount from about and including 25% by weight or less in some embodiments, or alternatively in a range of 1-25% by weight in other embodiments, In one embodiment, if glycol or another long chain alcohol is added to the flux mixture, the weight percentage of the oil based carrier used is preferably reduced proportionately while maintaining the same weight percentage of flux power in the mixture to provide optimum brazing performance and bonding.

In using the vanishing oil and fluoride based flux brazing mixture gel to prepare a braze filler metal delivery system in which the filter metal 150 is mixed directly into the flux 140 as shown in FIG. 5 and described above, the flux mixture comprises NOCOLOK® flux, Evaplube vanishing oil (e.g. Evap-Lube 2200), and powdered aluminum. In various embodiments, the aluminum content of the flux 140 gel/paste may be in the range of about 10-50% Al powder by weight. In one representative example, for illustration, approximately 60 g/m² of aluminum powder may be added which may be AlSi in sonic embodiments. To make a an aluminum preparation having a paste-like consistency For mixing with the flux gel, approximately 90 g/m² of Evaplube may added to that amount of aluminum powder. Approximately 25 g/m2 NOCOLOK® flux and about 35 g/m2 Evap-Lube 2200 are used in the oil based carrier flux gel mixture, as described above. Adding up all of the foregoing constituents, the aluminum powder is therefore about 30% of the total (210 g/m2) filler metal-flux gel mixture by weight in this example when combined to form a flux gel or paste that is applied to the bare tube surfaces.

In one embodiment, the aluminum particle size of the aluminum or AlSi power may be without limitation about 5-10 microns.

An exemplary method for bonding an aluminum fin 110 to a bare steel tube 102 will now he described based on the foregoing parameters and materials.

The method generally begins by first providing a preassembly of individual components as shown in either FIG. 4, 5, or 6 which have been describe above. Essentially, a bare steel tube 102 is provided and sets of aluminum fins 110 which comprise the main parts that are to be brazed and bonded together. Tube 102 may be stainless steel in this example such as Type 409SS. Fins 110 may be aa3003 aluminum.

Tube 102 is initially cleaned using a suitable cleaner to remove drawing oils and grime in preparing the outer surface 124 of the tube for receiving flux 140 which may be provided in a gel or paste form in the present embodiment. Water based cleaners may be used, and alternatively in other possible embodiments acetone may be used, ideally, the outer surface 124 of tube 102 along top and bottom flat walls 130a, 130b where fins 110 will be bonded should be thoroughly clean of contaminants that might adversely affect the formation of a good brazed joint between the tube and fins.

Next, the oil based carrier flux 140 mixture brazing gel or paste is applied to tubes 102. The flux 140 is applied to the outer surface 124 of tube 102 along top and. bottom hat walls 130a, 130b (see, e.g. FIGS. 4-6) before the fins 110 are placed against in surface contact with the tube surfaces and flux. in the embodiment of FIG, 5, the flux 140 will contain the AlSi filler metal 150 as already described herein. In the embodiments of FIGS. 4 and 6, the flux will generally not contain any filler metal 150 which is provided by other ways described herein such as by being clad onto the fins 110 (FIG. 4) or provided in the form of separate sheets of foil (FIG. 6).

The method next continues by bringing the tube 102 with flux 140 applied and fins 110 into surface contact with each other and forming the preassembly shown in FIGS. 4 and 5. With respect to FIG. 6, the AlSi filler metal foil 152 is placed on the flux 140 preferably after it is applied to tube 102, and then the fins are brought into surface contact with the foil adhered to the tube by the gel or paste like flux.

The foregoing assembled but Imbrued finned tube assemblies 104 as shown in FIGS. 4-6 are held together by any suitable means such as clamping in preparation for processing the brazing furnace.

The tube assembly 104 is next loaded into a brazing furnace, heated to a suitable brazing temperature and held at that temperature for a sufficient period of time to form a permanent bond between the aluminum fins 110 and the tube 102, as already described herein. The bonded tube assembly 104 is then cooled and removed from the brazing furnace.

In an alternative method for bonding fins 110 to tube 102 and forming a completed tube assembly, the brazing process may be applied to half-tube segments comprised of one set of fins 110 and one of the flat wall 130a or 130b (see, e.g. FIG. 3). For example, a first set of fins 110 may be brazed onto flat wall 130a, and a second set of fins may be brazed onto flat wall 130b. Then, the two brazed half tubes may be joined together by to suitable method such as welding to produce the completely tube assembly 104 shown in FIG. 2A. This fabrication technique allows gravity to assist the flow oldie braze material into the braze joint.

According to another embodiment, a tube assembly 104 comprised of a bare carbon steel tube 102 and fins 110 may be fabricated in according with the foregoing method. In one embodiment, low carbon steel having a wall thickness T1 of about 0.060 inches may be used. In another embodiment, a low carbon steel having a chrome (Cr) content of 0.1-0.25% may be used with a wall thickness T1 of 0.060 inches. The construction may use a brazing filler metal 150 in the form of foil 152 shown in FIG. 6 made of aa4045 aluminum with a sheet thickness of about 0.015 inches. The flux 140 may be a NOCOLOK® and Evaplube mixture as described herein, and in some possible embodiments an aluminum or AlSi filler in the form of flakes or powder may be added to the flux mixture. A water based cleaner is preferred to prepare the tube 102 for brazing that removes rust, and other surface contaminants from outer surface 124 of the tube; however, other suitable cleaning solutions may be used. Preferably, the flux is applied immediately after cleaning to prevent reoccurrence of oxide formation on the tube. In some embodiments, a binder may be added to the flux mixture to dry the flux for handling.

While the invention has been described and illustrated in sufficient detail that those skilled in this art can readily make and use it, various alternatives, modifications, and improvements should become readily apparent without departing from the spirit and scope of the invention.

1. A tube assembly for a heat exchanger comprising:
a bare steel tube; and
at least one set of aluminum fins bonded directly to an exposed outer surface of the bare steel tube by a brazing filler metal comprised of aluminum.

2. The tube assembly of claim 1, wherein the brazing filler metal comprises aluminum and silicon.

3. The tube assembly of claim 1, wherein the brazing filler metal comprises about 6-12% silicon.

4. The tube assembly of claim 1, wherein the set of aluminum fins has a serpentine configuration comprising peaks and valleys.

5. The tube assembly of claim 1, wherein the steel tube is made of stainless steel.

6. The tube assembly of claim 1, wherein the steel, tube has an oblong cross-sectional shape.

7. The tube assembly of claim 6, wherein steel tube includes substantially flat top and bottom walls, the aluminum fins being bonded to the flat top or bottom wall.

8. The tube assembly of claim 7, wherein the steel tube is comprised of segments joined together.

9. The tube assembly of claim 7, wherein steel tube is formed as a single unitary structure.

10. The tube assembly of claim 1, wherein the aluminum fins are cladded having a composite construction including a core of aluminum and the brazing filler metal cladded onto opposing sides of the core.

11. The tube assembly of claim 10, wherein the brazing filler metal comprises aluminum and silicon.

12. The tube assembly of claim 1, wherein the brazing filler metal comprises about 6-12% silicon.

13. The tube assembly of claim 1, wherein the steel tube has an oblong cross-sectional shape having a width of about 4 to 18 inches and a tube wall thickness T1 of about 0.035 to 0.12 inches.

14. The tube assembly of claim 1, wherein the steel tube has a longitudinal length of about 10-60 feet.

15. The tube assembly of claim 1, wherein the fins are comprised of aa3003 aluminum.

16. The tube assembly of claim 1, wherein the bare steel tube is comprised of low carbon steel or low carbon steel with chrome.

17. The tube assembly of claim 1, wherein the bare steel tube is comprised of Grade 409 or Grade 3Cr12 stainless steel.

18. A finned tube brazing preassembly for heat processing in a brazing furnace comprising:
a bare steel tube having an exposed outer surface;
a set of aluminum fins;
a fluoride based flux and oil based carrier mixture disposed between the bare steel tube and the set of aluminum fins; and
a brazing filler metal comprising aluminum, the brazing filler being disposed proximate to the set of aluminum fins and the flux and oil based carrier mixture;
wherein the brazing filler metal forms a brazed bond between the bare steel tube and set of aluminum fins when heat processed in the brazing furnace.

19-41. (canceled)

42. A method for forming a tube assembly for an air cooled condenser, the method comprising:
providing a bare steel tube having an exposed exterior surface of steel;
providing an aluminum fin;
applying a flux and oil based carrier mixture onto the exposed exterior surface of the steel tube;
providing a brazing filler metal;
bringing into mutual contact the bare steel tube, aluminum fin, flux and oil based carrier mixture, and brazing filler metal, wherein the bare steel tube, aluminum fin, flux and oil based carrier mixture, and brazing filler metal collectively define a finned tube brazing preassembly;
loading the finned tube brazing preassembly into a brazing furnace; and
heating he finned tube brazing preassembly to a ten erasure sufficient to melt the brazing filler metal and bond the aluminum tin directly onto the bare steel tube.

43. (canceled)

44. The method of claim 42, wherein the flux and oil based carrier mixture is comprised of about 40-65% by weight oil based carrier.

45-70. (canceled)
